(19) United States
(12) Patent Application Publication
(10) Pub. No.: US 2009/0223729 A1
(43) Pub. Date: Sep. 10, 2009

(54) POWER-DRIVEN DEVICE

(76) Inventor: Bradley KOSTYAK, Carlisle, PA (US)

Correspondence Address: MCNEES WALLACE & NURICK LLC, 100 PINE STREET, P.O. BOX 1166, HARRISBURG, PA, 17108-1166, US

(21) Appl. No.: 12/400,851

(22) Filed: Mar. 10, 2009

Related U.S. Application Data
(60) Provisional application No. 61/068,741, filed on Mar. 10, 2008.
(60) Provisional application No. 61/124,489, filed on Apr. 18, 2008.

(51) Int. Cl. B62D 51/04; B62D 61/00

(52) U.S. Cl. 180/218

(57) ABSTRACT

A power-driven device and a method of powering a power-driven device are disclosed. The power-driven device includes a body, at least one wheel configured to support the body, and a drive shaft in rotational communication with one or more of the at least one wheel, the drive shaft being in rotational communication with a drive interface, the drive interface being configured to releasably rotatably communicate with a motor-driven flexible drive shaft.

### CROSS-REFERENCE TO RELATED APPLICATIONS

This application claims priority from and the benefit of U.S. Provisional Application No. 61/068,741 entitled UTILITY CART PROPELLED BY STRING TRIMMER POWER HEAD, filed Mar. 10, 2008, which is hereby incorporated by reference in its entirety and U.S. Provisional Application No. 61/124,489 entitled UTILITY CART PROPELLED BY STRING TRIMMER POWER HEAD, filed Apr. 18, 2008, which is hereby incorporated by reference in its entirety.

### FIELD

The present disclosure generally relates to a power-driven device and method for powering a power-driven device. In particular, the present disclosure relates to a modular device having a drive interface configured for releasably rotatably communicating with a motor-driven flexible drive shaft.

### BACKGROUND

Hauling loads has long been a task performed by individuals. Wheelbarrows, carts, and hand trucks have long been used to facilitate hauling loads. Generally these devices include a hauling portion and an operator portion. The hauling portion carries the load and the operator portion is controlled by the operator. These devices assist individuals in hauling loads that would not otherwise be too heavy or too awkward. However, the loads can remain too heavy for many people to handle. In addition, repetitive hauling of the loads can result in health problems and/or physical stress. Similarly, for example, mowing lawn, snow-blowing, aerating lawn, spreading substances on lawns or other areas may result in health problems and/or physical stress. Often, each of these tasks is performed by a different device. This results in individuals purchasing and storing numerous tools to perform separate tasks.

Generally, motorized devices can aid in the above tasks. Motorized devices can include a hauling portion similar to those in wheelbarrows, carts, and hand trucks. Motorized hauling devices typically include a permanently installed motor. Having a permanent motor can result in motorized hauling devices being heavy and expensive. For example, the cost of the motorized hauling device may include the cost of the hauling portion, the cost of the operator portion, and the cost of the motor. In addition, the motor is difficult and expensive to maintain and repair. Electric motorized hauling devices can require recharging and/or may have power limitations.

Motorized hauling devices having permanently installed motors typically include a motor mounted near the ground. Positioning the motor near the ground can increase risk of contaminants entering the motor and/or prevent operation in shallow water. Positioning the motor near the ground can also result in more weight being distributed on the hauling portion of the motorized hauling device. In addition, positioning the motor near the ground can require additional features and/or equipment to permit control of the motor at the operator portion of the motorized hauling device.

What is needed is a device having improved capability of providing power and/power assistance for performing a plurality of tasks, having decreased production costs, is easily maintained and repaired, is lightweight and includes improved operational features.

### SUMMARY OF THE DISCLOSURE

One aspect of the present disclosure includes a power-driven device includes a body, at least one wheel configured to support the body, and a drive shaft in rotational communication with one or more of the at least one wheel, the drive shaft being in rotational communication with a drive interface, the drive interface being configured to releasably rotatably communicate with a motor-driven flexible drive shaft.

Another aspect of the present disclosure includes a gas-powered device includes a body for hauling, at least one wheel configured to support the body, and a drive shaft in rotational communication with one or more of the at least one wheel, the drive shaft having a drive interface, the drive interface being configured to releasably rotatably communicate with a motor-driven flexible drive shaft. In the embodiment, the drive interface is further configured to releasably rotatably communicate with the motor-driven flexible drive shaft by manual engagement, the motor-driven flexible drive shaft is a disengaged portion of a rotary cutting assembly, and the motor-driven drive shaft is configured to be rotated by a motor, the motor having a horse power of less than about five horse power.

Still another aspect of the present disclosure includes a method of powering a device includes providing a body, providing at least one wheel configured for supporting the body, providing a drive shaft in rotational communication with one or more of the at least one wheel, the drive shaft having a drive interface, the drive interface being configured to releasably rotatably communicate with a motor-driven flexible drive shaft of a disengaged portion of a rotary cutting assembly, and manually inserting the disengaged portion of the rotary cutting assembly into the drive interface, thereby placing the motor-driven flexible drive shaft in rotational communication with the drive interface.

One advantage of the present disclosure includes the ability to provide power to assist in moving a device that does not include a permanently installed motor.

Another advantage of the present disclosure includes using a motor from another device, which is easily removed for repair and/or maintenance.

Another advantage of the present disclosure includes the ability to operate the device in conditions, such as shallow water.

Another advantage of the present disclosure includes a lightweight device that is easily stored and/or transported.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 shows a rotary cutting assembly.

FIG. 2 shows a sectional view of the rotary cutting assembly of FIG. 1.

FIG. 3 shows a sectional view of the rotary cutting assembly of FIG. 1 in a detached configuration.

FIG. 4 shows a top view of the device according to one embodiment of the disclosure.

FIG. 5 shows a top view of the device according to another embodiment of the disclosure.

FIG. 6 shows a top view of the device according to another embodiment of the disclosure.

FIG. 7 shows a top view of the device according to another embodiment of the disclosure.

FIG. 8 shows a right side view of the device according to the embodiment of FIG. 7.

FIG. 9 shows a left side view of the device according to the embodiment of FIG. 7.

FIG. 10 shows a top view of the device according to another embodiment of the disclosure.

FIG. 11 shows a right side view of the device according to another embodiment of the disclosure.

Wherever possible, the same reference numbers will be used throughout the drawings to represent the same parts.

### DETAILED DESCRIPTION

FIG. 1 shows a rotary cutting assembly 12. The rotary cutting assembly 12 can include a motor 13, a casing 14, and a cutting element 15. Motor 13 can be connected to cutting element 15 by a drive shaft (not shown in FIG. 1) enclosed by casing 14. Motor 13 can be any suitable gas or electric motor configured for converting a stored power source or fuel into rotational movement of the drive shaft. Motor 13 can include variable speeds, quiet operation features, manual throttle, bidirectional capability, and/or other suitable features. In one embodiment, motor 13 may have a horse power of five horse power or less, between one horse power and five horse power, two or less horsepower or one or less horsepower. By manipulating casing 14, an operator 11 can position rotary cutting assembly 12 to cut desired areas of vegetation or other suitable areas.

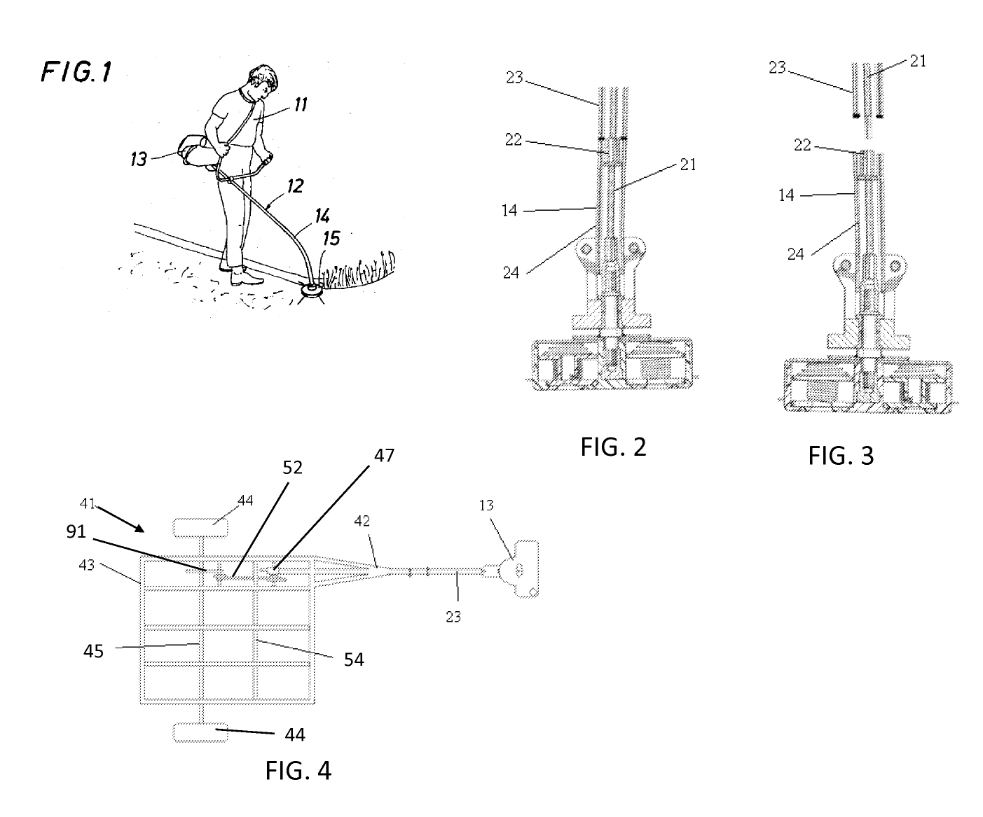

Referring to FIGS. 1 and 2, the drive shaft in the rotary cutting assembly 12 can be a flexible drive shaft 21. Flexible drive shaft 21 can be rotated by motor 13. Flexible drive shaft 21 can include a coupling portion 22 configured to couple a first portion 23 to a second portion 24. Second portion 24 can be positioned on the end of flexible drive shaft 21 near cutting element 15. In another embodiment, coupling portion 22 may be positioned within casing 14 farther from cutting element 15. In this embodiment, first portion 23 may be connected to an additional flexible drive shaft, a rigid drive shaft, or any other suitable element configured for rotational movement. In another embodiment, coupling portion 22, first portion 23, and/or second portion 24 may include threaded portions.

Referring to FIGS. 2 and 3, first portion 23 of rotary cutting assembly 12 can be selectably engaged and disengaged from second portion 24. To engage first portion 23 with second portion 24, first portion 23 can be inserted into a coupling portion 22 of second portion 24. Coupling portion 22 can be threaded and/or include retention features to assist engagement. To disengage first portion 23 from second portion 24, first portion 23 can be pulled from, screwed out of, and/or otherwise removed from coupling portion 22 of second portion 24. Upon being disengaged from second portion 24, first portion 23 can be inserted into a drive interface 42 of a power-driven device 41 (see FIG. 4). In one embodiment, engagement and/or disengagement may be performed manually with or without the assistance of tools.

FIG. 4 shows an exemplary embodiment of power-driven device 41. Device 41 can include a body 43. Body 43 can be a substantially planar configuration of bars forming a surface for hauling loads. Body 43 can be any suitable material including, but not limited to, metals, composites, and/or wood. Body 43 may be configured for hauling loads, mowing lawns, snow-blowing, plowing, aerating lawns, and/or spreading substances (for example, seed, fertilizer, water, and/or salt). Body 43 can be supported by at least one wheel 44. Wheel 44 can be in rotational communication with a drive shaft 45, which may include an axel or similar structure to support and drive wheels 44. In one embodiment, the rotational communication of wheel 44 and drive shaft 45 may be selectably engaged and disengaged by a control mechanism 51, thereby selectively providing rotation to wheel 44.

Drive interface 42 can be in selective rotational communication with drive shaft 45. Drive interface 42 can receive a disengaged first portion 23 of rotary cutting assembly 12. Drive interface can include coupling portion 22 and/or other suitable features permitting drive interface 42 to releasably rotatably communicate with flexible drive shaft 21. Thus, drive interface 42 may include belts, chains, couplings, clutches or any other suitable structure that is capable of permitting flexible drive shaft 21 to be in rotational communication with drive shaft 45 and/or wheel(s) 44. In one embodiment, drive interface 42 directly receives flexible drive shaft 21. In another embodiment, drive interface 42 receives an intermediate feature (not shown) in rotational communication with flexible drive shaft 21. In one embodiment, the insertion, removal, engagement, and/or disengagement can be performed manually (for example, by tightening hand screws).

Drive interface 42, as shown in FIG. 4, includes a gear mechanism 47, which rotates a pulley or similar device that drives a belt 52, which rotates a sprocket or other suitable device that drives a chain 91. The gear mechanism 47 includes any suitable mechanism capable of converting the high rotational speed of the flexible shaft 21 to a lower speed higher power. Suitable gearing may include a worm gear arrangement that rotates a pulley or other belt driving device.

Upon first portion 23 being engaged to drive interface 42, device can be power-driven by motor 13. Engagement allows flexible drive shaft 21 to rotatably communicate with drive interface 42 the drive interface and drive shaft 45. In one embodiment, upon first portion 23 being engaged to drive interface 42, motor 13 may be positioned distal from body 43. This may permit operator 11 to control motor 13 and/or use the weight of motor 13 for balance. In another embodiment upon first portion 23 being engaged to drive interface 42, motor 13 may be positioned elevated in elation to body 43. This may provide operator 11 additional leverage, additional maneuverability, and/or the ability to used device 41 in other areas (for example, in shallow water or higher brush).

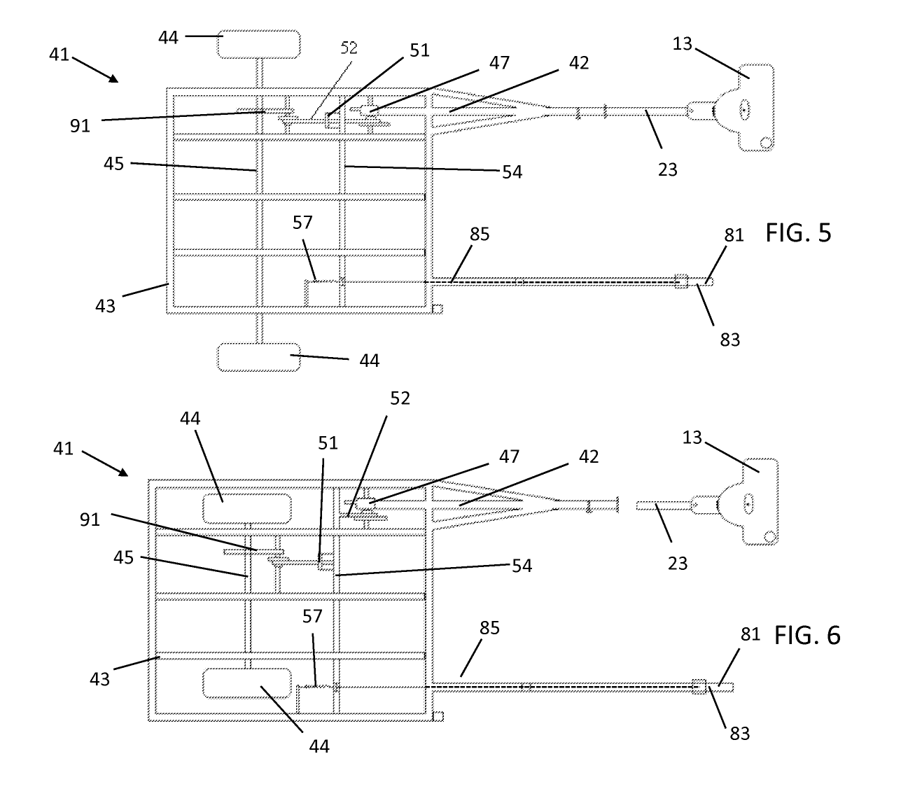

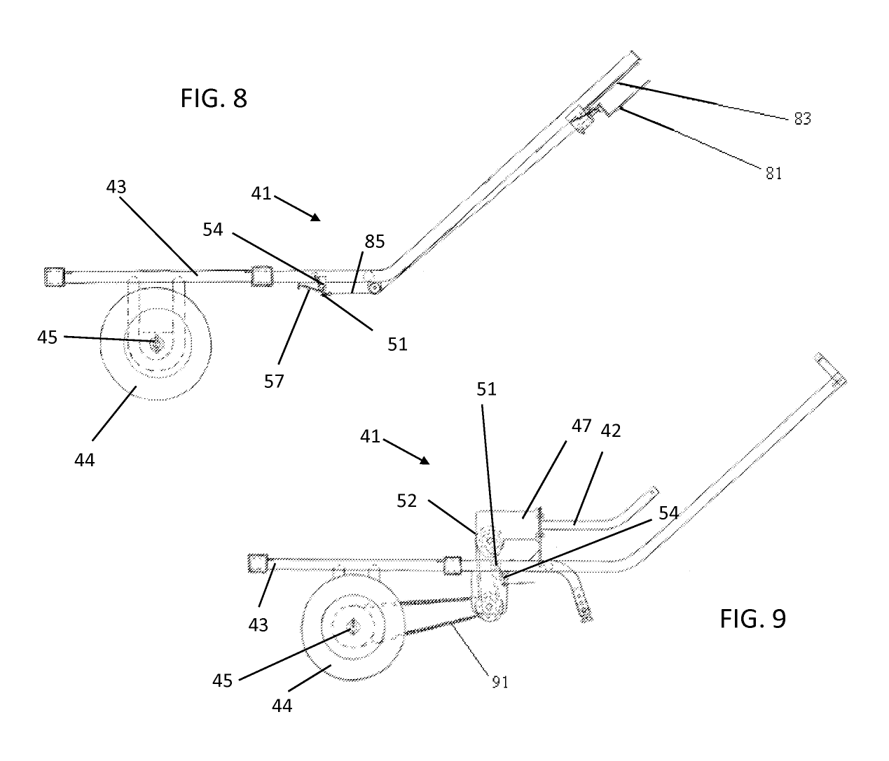

Referring to FIGS. 5-11, the device 41 can include control mechanism 51. Control mechanism 51 can selectably engage and disengage drive shaft 45 from rotational communication with wheel 44 of body 43. Selective engagement and disengagement can be performed by any suitable configuration. For example, selective engagement and disengagement can be performed by depressing a trigger 81. Trigger 81 can be configured to remain depressed until a separate trigger 83 releases it (see e.g., FIG. 8). Depressing trigger 81 can rotate secondary shaft 54 by drawing a control wire 85 or other structure to rotate secondary shaft 54. Rotation of secondary shaft 54 engages or disengages belts 52 and/or chains 91 and places drive shaft 45 and/or wheel 44 in rotational communication with flexible drive shaft 21. For example, the rotation of secondary shaft 54 may provide increased tension between a belt 52 and one or more pulleys or other structures thereby permitting rotational communication between the flexible drive shaft 21 and drive shaft 45. When engaged with tension, the motor-driven rotation of the flexible drive shaft 21 provides powered rotation to the wheel 44. Released tension may permit the drive shaft to spin substantially unrestricted. Increasing the tension can also result in slowing of wheel 44 by frictional force being applied to belts 52 and/or chains 91 and/or rotating wheel 44 when flexible drive shaft 21 is not rotating, such as when the motor 13 is deactivated. The tension and release of tension by the control mechanism 51 may be assisted or driven by a spring 57 or similar device that provides a force to rotate secondary shaft 54.

Referring to FIG. 6, device 41 is shown with first portion 23 being disengaged from drive interface 42 of device 41. As shown, wheels 44 can be positioned within body 43. In other embodiments more or fewer wheels 44 may be included. One or more wheels 44 may be in rotational communication with drive shaft 45. Additionally or alternatively, wheels 44 may be positioned in a plurality of rows or other arrangements (for example, one in front and two in back). Likewise drive shaft 45 may include multiple drive shafts 45 or other structures to provide powered rotation to wheels 44. In other embodiments, more control mechanisms 51 may be included. Additionally or alternatively, multiple motor-driven flexible drive shafts 21 may be included, thereby permitting wheels 44 to be controlled by separate motor-driven flexible drive shafts 21.

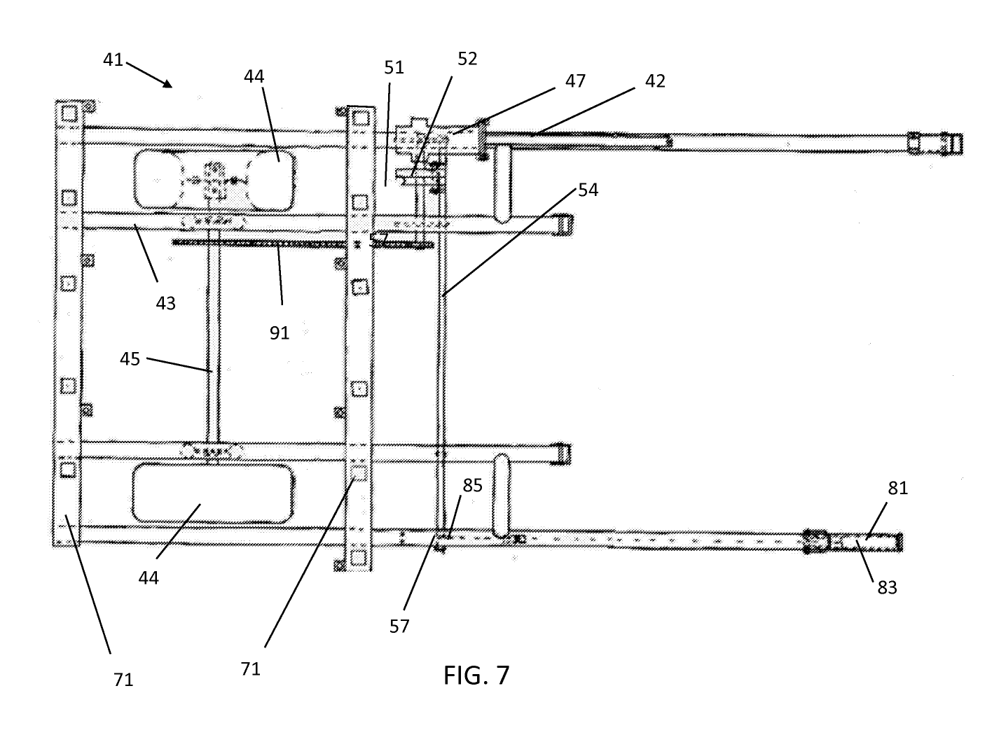

Referring to FIG. 7, body 43 of device 41 can include attachment features 71 for receiving attachments (not shown). The attachments may be releasably attached to body permitting device 41 to be used for suitable applications as discussed above. Suitable attachments may include having structures such as snow blowing attachment structures, mowing attachment structures, lawn aerating attachment structures, spreading attachment structures, or any other attachment structure desired to be power driven. The attachment feature 71 may include opening latches, hooks, or any other structure or feature that permits mounting of attachment structures.

Referring to FIG. 8, the control mechanism 51 includes trigger 81, which draws control wire 85 to rotate secondary shaft 54. The secondary shaft 54 rotates and increases or decreases the tension in belt 52 in the drive interface 42. A spring 57 provides a force to allow the wire the trigger to return to an unengaged position and to maintain tension in control wire 85. Separate trigger 83 includes a latch or lock or feature that permits engagement and disengagement of trigger 81.

Referring to FIG. 9, the drive interface 42 includes a gear mechanism 47, which rotates and drives belt 52. Control mechanism 51 includes a pulley that increases or decreases tension in the belt 52 to engage or disengage the rotational communication from the flexible drive shaft 21 to the drive shaft 45. The belt 52 drives a chain 91, which drives drive shaft 45. Various gear ratios can be provided in the pulleys and belt 52 and in the chain 91 to provide desired toque for the desired applications.

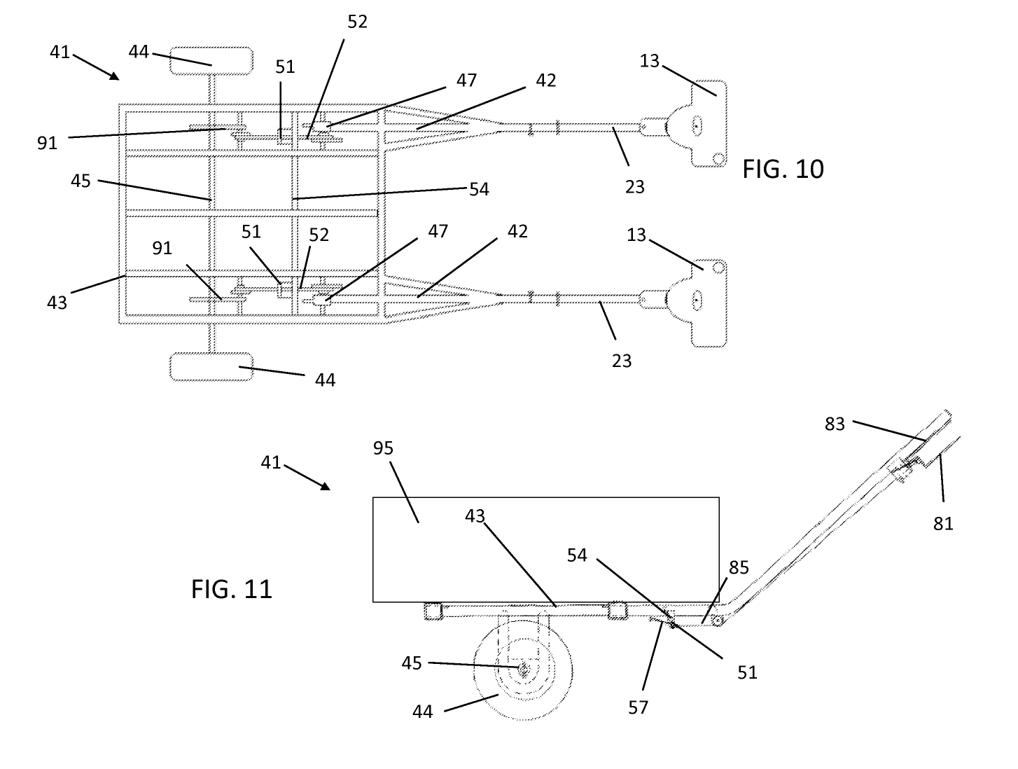

Referring to FIG. 10, the device 41 includes two drive interfaces 42 for receiving motor driven flexible drive shafts 21. In this embodiment additional control can be provided by providing selective power from each of the motor driven flexible drive shafts 21. In addition, greater power may be provided from the dual motors 13. Control mechanism 51 may be utilized to engage and disengage flexible drive shafts 21 together or independently. Rotation of secondary shaft 54 may be provided by any suitable technique including handles or triggers to engage or disengage the control mechanism 51.

Referring to FIG. 11, an arrangement substantially as shown in FIG. 8 with a payload 95 mounted on body 43. While FIG. 11 is shown with a payload 95, the device 41 is not so limited and may include any suitable attachment or hauling structure.

While the above has been shown and described with exemplary arrangements of gearing, belts and chain configurations, the disclosure is not so limited. The drive interface may include any arrangement that provides torque conversion from the high speed of the motor-driven flexible drive shaft 21 to the drive shaft 45. In addition, other features, such as brakes, clutches, steering or other controls may include included in the device 41.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A power-driven device, comprising:
a body;
at least one wheel configured to support the body; and
a drive shaft in rotational communication with one or more of the at least one wheel, the drive shaft being in rotational communication with a drive interface, the drive interface being configured to releasably rotatably communicate with a motor-driven flexible drive shaft.

2. The device of claim 1, wherein the drive interface is further configured to releasably rotatably communicate with the motor-driven flexible drive shaft by manual engagement.

3. The device of claim 1, wherein the drive interface is further configured to releasably directly engage the motor-driven flexible drive shaft.

4. The device of claim 1, wherein the motor-driven flexible drive shaft is a disengaged portion of a rotary cutting assembly.

5. The device of claim 4, further comprising a first portion of a casing configured to enclose at least a portion of the flexible drive shaft, the casing being separable into the first portion and a second portion, the first portion being insertable into the drive shaft of the device.

6. The device of claim 5, further comprising:
the first portion of the casing; and
a motor; and
wherein the motor is at a distal position along the first portion of the casing in relation to the drive interface.

7. The device of claim 6, wherein the motor is elevated above the body of the device.

8. The device of claim 1, wherein the device is gas-powered.

9. The device of claim 1, wherein the motor-driven flexible drive shaft is configured to be rotated by a motor, the motor having a horse power of less than about five horse power.

10. The device of claim 1, wherein the motor-driven flexible drive shaft is configured to be rotated by a motor, the motor having a horse power of less than about one horse power.

11. The device of claim 1, further comprising a control mechanism, the control mechanism being configured to selectably engage and disengage an axle in rotational communication with the at least one wheel.

12. The device of claim 1, further comprising a control mechanism, the control mechanism being configured to selectably engage and disengage the drive shaft from rotational communication with the at least one wheel.

13. The device of claim 1, wherein the body includes attachments configured to haul loads.

14. The device of claim 1, wherein the body includes attachments configured to mow lawns.

15. The device of claim 1, wherein the body includes attachments configured to snow-blow.

16. The device of claim 1, wherein the body includes attachments configured to aerate lawns.

17. The device of claim 1, wherein the body includes attachments configured to spread substances.

18. The device of claim 1, further comprising a second drive shaft in rotational communication with at least one additional wheel, the second drive shaft being configured to releasably rotatably communicate with a second motor-driven flexible drive shaft.

19. A gas-powered device, comprising:
a body for hauling;
at least one wheel configured to support the body; and
a drive shaft in rotational communication with one or more of the at least one wheel, the drive shaft having a drive interface, the drive interface being configured to releasably rotatably communicate with a motor-driven flexible drive shaft,
wherein the drive interface is further configured to releasably rotatably communicate with the motor-driven flexible drive shaft by manual engagement,
wherein the motor-driven flexible drive shaft is a disengaged portion of a rotary cutting assembly, and
wherein the motor-driven drive shaft is configured to be rotated by a motor, the motor having a horse power of less than about five horse power.

20. A method of powering a device, comprising:
providing a body;
providing at least one wheel configured for supporting the body;
providing a drive shaft in rotational communication with one or more of the at least one wheel, the drive shaft having a drive interface, the drive interface being configured to releasably rotatably communicate with a motor-driven flexible drive shaft of a disengaged portion of a rotary cutting assembly;
manually inserting the disengaged portion of the rotary cutting assembly into the drive interface, thereby placing the motor-driven flexible drive shaft in rotational communication with the drive interface.
